(19) United States
(12) Patent Application Publication
(10) Pub. No.: US 2013/0047014 A1
(43) Pub. Date: Feb. 21, 2013

(54) COMMUNICATION APPARATUS AND COMPUTER PROGRAM PRODUCT

(71) Applicants: Kotaro ISE, Kanagawa (JP); Takeshi ISHIHARA, Kanagawa (JP); Masataka GOTO, Kanagawa (JP); Yoshimichi TANIZAWA, Kanagawa (JP)

(72) Inventors: Kotaro ISE, Kanagawa (JP); Takeshi ISHIHARA, Kanagawa (JP); Masataka GOTO, Kanagawa (JP); Yoshimichi TANIZAWA, Kanagawa (JP)

(21) Appl. No.: 13/535,869

(22) Filed: Jun. 28, 2012

(30) Foreign Application Priority Data
Aug. 19, 2011 (JP) 2011-179726

(51) Int. Cl. G06F 1/00

(52) U.S. Cl. 713/320

(57) ABSTRACT

According to an embodiment, a communication apparatus includes a data reception controller configured to receive data from an external device functioning in an active state via a network and store the data in a buffer; a remote controller configured to, when a predetermined condition is satisfied, issue a request to the external device to switch to a power saving state; and a processor configured to process the data stored in the buffer.

### CROSS-REFERENCE TO RELATED APPLICATIONS

This application is based upon and claims the benefit of priority from Japanese Patent Application No. 2011-179726, filed on Aug. 19, 2011; the entire contents of which are incorporated herein by reference.

### FIELD

Embodiments described herein relate generally to a communication apparatus and a computer program product.

### BACKGROUND

Typically, a technique is known for reducing the power consumption of a device. In that technique, regarding a particular hardware component included in the device, electric power is supplied only when that hardware component is in use.

Moreover, in a communication apparatus that communicates with other devices via a network, in order to reduce the power consumption of a device on the other side of communication, a known technique such as Wake-On-LAN (WOL, where LAN stands for Local Area Network) is implemented to control the switching ON or switching OFF of the power supply to that device via the network.

However, in the abovementioned technique of controlling the switching ON or switching OFF of the power supply to a device on the other side of communication via a network, switching ON or switching OFF the power supply to the other device is generally controlled in synchronization with switching ON or switching OFF the power supply to the communication apparatus that performs such control. Such a configuration leaves room for enhancement in the reduction of the power consumption.

### BRIEF DESCRIPTION OF THE DRAWINGS

FIG. 1 is a configuration diagram illustrating an example of a communication system according to a first embodiment;

FIG. 2 is a sequence diagram illustrating an example of typical operations performed in the communication system according to the first embodiment;

FIG. 3 is a configuration diagram illustrating an example of a television (TV) according to the first embodiment;

FIG. 4 is a diagram illustrating an example of a contents selection screen according to the first embodiment;

FIG. 5 is a diagram illustrating an exemplary format of a startup request according to the first embodiment;

FIG. 6 is a diagram illustrating an exemplary format of a startup notification according to the first embodiment;

FIG. 7 is a configuration diagram illustrating an example of a network attached storage (NAS) according to the first embodiment;

FIG. 8 is a flowchart for explaining exemplary operations of a remote control unit and a remote managing unit according to the first embodiment;

FIG. 9 is a flowchart for explaining an example of operations performed by a data reception control unit according to the first embodiment;

FIG. 10 is a configuration diagram illustrating an example of a communication system according to a first modification example;

FIG. 11 is a sequence diagram illustrating an example of typical operations performed in the communication system according to the first modification example;

FIG. 12 is a diagram illustrating an example of the contents selection screen according to a fifth modification example;

FIG. 13 is a configuration diagram illustrating an example of a communication system according to a sixth modification example;

FIG. 14 is a configuration diagram illustrating an example of a communication system according to a second embodiment;

FIG. 15 is a sequence diagram illustrating an example of typical operations performed in the communication system according to the second embodiment;

FIG. 16 is a diagram illustrating an example of operations performed in the communication system according to the second embodiment in the case when a printer is manually switched ON;

FIG. 17 is a configuration diagram illustrating an example of a print server according to a second embodiment; and

FIG. 18 is a configuration diagram illustrating an example of a printer according to the second embodiment.

### DETAILED DESCRIPTION

According to an embodiment, a communication apparatus includes a data reception controller configured to receive data from an external device functioning in an active state via a network and store the data in a buffer; a remote controller configured to, when a predetermined condition is satisfied, issue a request to the external device to switch to a power saving state; and a processor configured to process the data stored in the buffer.

### First Embodiment

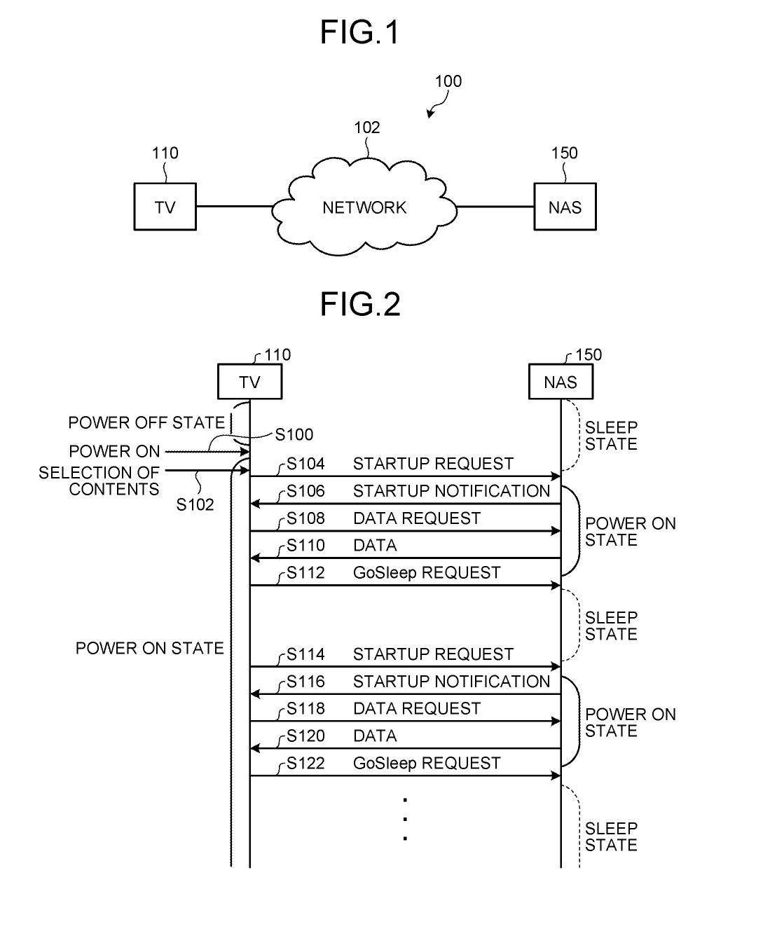

FIG. 1 is a configuration diagram illustrating an example of a communication system 100 according to a first embodiment. The communication system 100 includes a television (TV) 110, which serves as a data receiving device (as an example of a communication apparatus), and a network attached storage (NAS) 150, which serves as a data transmitting device (as an example of an external device). The TV 110 and the NAS 150 are connected to each other via a network 102. Meanwhile, it is also possible to install two or more TVs and two or more NASs.

In the first embodiment, the explanation is given for a case in which the network 102 is a home network (home LAN) used in a home. However, that is not the only possible case, and the network 102 can be any other type of network.

In the first embodiment, it is assumed that the TV 110 and the NAS 150 can communicate with each other using the IP protocol, and that a protocol defined according to, for example, the digital living network alliance (DLNA) is used as the higher-level protocol. However, that is not the only possible case, and other types of protocols can also be used.

In the first embodiment, the NAS 150 can switch between three power states as far as the electric power is concerned. That is, the NAS 150 can switch between in a power ON state (as an example of an active state), a power OFF state, and a sleep state (as an example of a power saving state). In the power ON state, various functions are in a usable state and, typically, the power is supplied to all circuits. In the power OFF state, the functions of the device are in an unusable state and, typically, the power is supplied to no circuit. Thus, in the power OFF state, the NAS 150 is not able to receive data (packets) from the network. In the sleep state, the function of receiving data (packets) from the network is in a usable state and the power consumption is lower than in the power ON state. Moreover, typically, the power is supplied to a network interface card (NIC) and a power managing circuit. Furthermore, while in the sleep state, in response to a request from another device such as the TV 110 via the network, the NAS 150 can switch to the power ON state.

Meanwhile, the power states of the NAS 150 are not limited to the three power states described above. For example, the sleep state can be further divided into a Deep sleep state and a Nap sleep state. In the Deep sleep state, the power consumption is lower than even the sleep state described above but switching to the power ON state takes a greater amount of time. In the NAP sleep state, the power consumption is higher than the sleep state described above but switching to the power ON state takes a smaller amount of time.

Regarding the TV 110, in the first embodiment, the purpose is served if the TV 110 has at least the two power states of the power ON state and the power OFF state, although it goes without saying that the TV 110 can be configured to switch between the same power states as that of the NAS 150.

FIG. 2 is a sequence diagram illustrating an example of typical operations performed in the communication system 100 according to the first embodiment. In the example illustrated in FIG. 2, it is assumed that the operations in the communication system 100 start when the TV 110 is in the power OFF state and the NAS 150 is in the sleep state.

Firstly, when a power switch (not illustrated) of the TV 110 is switched ON by, for example, a user or a timer (Step S100), the TV 110 switches from the power OFF state to the power ON state.

Subsequently, when the user performs a display operation for displaying a contents selection screen, the TV 110 displays a contents selection screen in which a list of contents titles is displayed. When the user selects, from the contents selection screen, contents to be viewed (Step S102); the TV 110 issues a startup request to the NAS 150, which is holding the selected contents, as a request to switch to the power ON state (Step S104). The details regarding the startup request are given later.

Upon receiving the startup request from the TV 110, the NAS 150 switches from the sleep state to the power ON state, and sends a startup notification to the TV 110 notifying that it has switched to the power ON state (Step S106). The details regarding the startup notification are given later.

Upon receiving the startup notification from the NAS 150, the TV 110 issues a data request to the NAS 150 as a request to send data of the contents selected at Step S102 (Step S108). In the data request, a request size is set that indicates the size of the requested data. The details regarding the data request are given later.

Upon receiving the data request from the TV 110, the NAS 150 starts sending the requested data (Step S110).

Then, the TV 110 starts receiving the data being sent by the NAS 150; and, while continuing to store the received data in a buffer, processes the stored data to play the contents. Herein, it is assumed that the data transfer rate (data transmission rate) from the NAS 150 to the TV 110 is higher than the data processing speed (contents playing rate) of the TV 110. Once the data equivalent to the request size is received or when the volume of data already stored in the buffer exceeds B_sleep (an example of a first threshold value), the TV 110 issues a GoSleep request to the NAS 150 as a request to switch to the sleep state (Step S112). The details regarding the GoSleep request are given later.

Upon receiving the GoSleep request from the TV 110, the NAS 150 switches from the power ON state to the sleep state. If the GoSleep request is received during the transmission of data to the TV 110, then the NAS 150 discontinues the data transmission.

Even after the discontinuation of data transfer (data transmission) from the NAS 150 to the TV 110, the TV 110 continues with the playing of the contents (i.e., continues with the processing of the data that is already stored in the buffer). When the volume of data already stored in the buffer falls below B_min (an example of a second threshold value), the TV 110 again issues a startup request to the NAS 150 (Step S114). Herein, B_min is a smaller value than B_sleep. (Meanwhile, in the case when the TV 110 performs fast-forwarding or the like that is different than the normal playing, the first embodiment can be implemented if the data that follows the point of playing is regarded as the volume of data already stored in the buffer). Subsequently, in the communication system 100, the operations identical to Steps S106 to S112 are performed at Steps S116 to S122. However, at Step S118, to the NAS 150, the TV 110 issues a request for the unreceived data (i.e., the data that follows the already-received data) from among the data of the contents selected at Step S102.

Then, in the communication system 100, until the TV 110 receives all data of the contents selected at Step S102, the operations from Step S114 to S122 are repeated.

While the TV 110 is playing contents, if the user performs an operation to abort the playing of contents, the TV 110 does not receive data after that point of time from the NAS 150. Thus, while in the process of receiving data from the NAS 150, irrespective of the volume of data that has already been stored in the buffer, the TV 110 issues a GoSleep request to the NAS 150. Moreover, while not receiving data from the NAS 150, irrespective of the volume of data that has already been stored in the buffer, the TV 110 does not issue a startup request to the NAS 150.

Furthermore, if the power switch of the TV 110 is switched OFF by, for example, a user or a timer; the TV 110 switches from the power ON state to the power OFF state. In that case too, if data was being received from the NAS 150, irrespective of the volume of data that has already been stored in the buffer, the TV 110 issues a GoSleep request to the NAS 150.

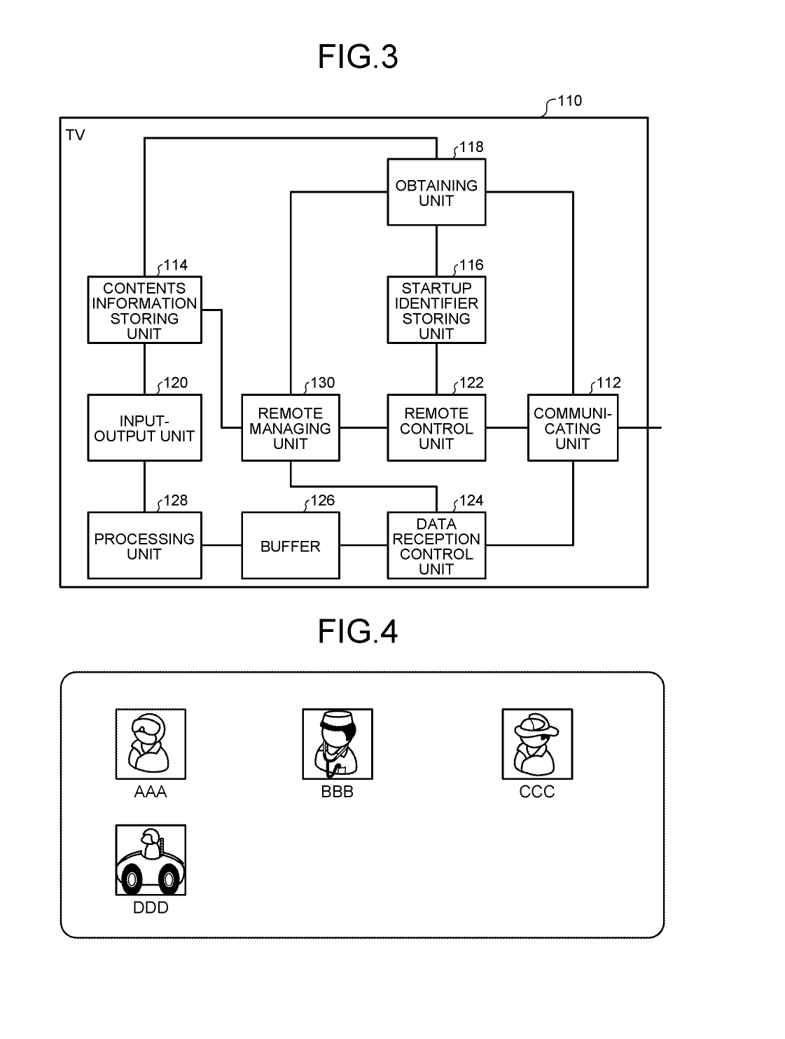

FIG. 3 is a configuration diagram illustrating an example of the TV 110 according to the first embodiment. As illustrated in FIG. 3, the TV 110 includes a communicating unit 112, a contents information storing unit 114, a startup identifier storing unit 116, an obtaining unit 118, an input-output unit 120, a remote control unit 122, a data reception control unit 124, a buffer 126, a processing unit 128, and a remote managing unit 130.

The communicating unit 112 communicates with external devices, such as the NAS 150, via the network 102; and is put into practice using an existing communication apparatus such as an NIC. In the first embodiment, the communicating unit 112 sends startup requests, data requests, and GoSleep requests, as well as receives startup notification and data. More specifically, in order to perform transmission and reception as mentioned above, the communicating unit 112 processes the Ethernet (registered trademark) physical layer, the MAC layer (MAC stands for Media Access Control), the IP layer (IP stands for Internet Protocol), and the transport layer (including the TCP/UDP layer) (TCP stands for Transmission Control Protocol and UDP stands for User Datagram Protocol). For example, as the processing of the transport layer, the communicating unit 112 performs HTTP processing (HTTP stands for HyperText Transfer Protocol).

The contents information storing unit 114 is used to store therein contents information of all pieces of contents that are held in a contents holding source device such as the NAS 150. The contents information storing unit 114 can be put into practice using any one of the existing memory devices that enable storage in a magnetic, optical, or electrical manner. For example, the contents information storing unit 114 can be a hard disk drive (HDD), a solid state drive (SSD), a memory card, an optical disk, or a random access memory (RAM).

In the first embodiment, it is assumed that a piece of contents information includes contents metadata, a contents access identifier, a contents size, and a device identifier. However, that is not the only possible combination.

The contents metadata represents the information that is referred to by the user at the time of selecting contents. For example, the contents metadata includes at least one of a contents title, a contents icon, a contents category (such as movie, drama, romance, violence, or the like), cast (such as Yamada Taro), and a contents length (such as 120 minutes).

A contents access identifier is the information used in a contents data request, and represents the means for accessing the contents as well as represents an identifier. For example, the contents access identifier is expressed in the form of a uniform resource locator (URL) as “http:://[host_ip]/contents/movie/AAA.wmv”. Herein, “host_ip” represents the IP address of a contents holding source device such as the NAS 150. Such usage is for dealing with a case when the IP address of the contents holding source device is not statically set (i.e., is changed dynamically). The data reception control unit 124 (described later) replaces “host_ip” in a contents access identifier with the latest IP address of the corresponding contents holding source device.

The contents size represents the data size, such as 100 MB (megabytes), of a set of contents.

The device identifier uniquely identifies the contents holding source device such as the NAS 150. As the device identifier, it is possible to use a universally unique identifier (UUID) or a fully qualified domain name (FQDN).

Meanwhile, in the first embodiment, it is assumed that the pieces of contents information stored in the contents information storing unit 114 are added, deleted, and updated by the obtaining unit 118 (described later). However, alternatively, the pieces of contents information can be added, deleted, or updated in a static manner without using the obtaining unit 118.

The startup identifier storing unit 116 is used to store therein startup identifiers. In an identical manner to the contents information storing unit 114, the startup identifier storing unit 116 can also be put into practice using any one of the existing memory devices. For each contents holding source device such as the NAS 150, the startup identifier storing unit 116 stores therein a startup identifier in a corresponding manner to the device identifier of that contents holding source device.

A startup identifier is the information used in a startup request for a contents holding source device. As a startup identifier, it is possible to use the Ethernet address (MAC address) of the corresponding contents holding source device. However, that is not the only possible case, and it is also possible to use any other identifier, such as the telephone number assigned to each terminal, as the startup identifier.

Moreover, in the first embodiment, it is assumed that the startup identifiers stored in the startup identifier storing unit 116 are added or deleted by the obtaining unit 118 (described later). However, alternatively, the startup identifiers can be added or deleted in a static manner without using the obtaining unit 118.

The obtaining unit 118 obtains, via the communicating unit 112, contents information from a contents holding source device, such as the NAS 150, and stores the contents information in the contents information storing unit 114. In an identical manner, the obtaining unit 118 obtains, via the communicating unit 112, a startup identifier from a contents holding source device, such as the NAS 150, and stores the startup identifier in the startup identifier storing unit 116.

For example, from the remote managing unit 130 (described later), the obtaining unit 118 obtains a list of IP addresses of devices in the power ON state, refers to the obtained list, and makes an inquiry to the listed devices about contents information. While inquiring about contents information, file information can be specified that limits the contents to be inquired. That file information can contain, for example, the contents title, the cast, the category, or the data size. As a result of the inquiry, if a particular piece of contents information is found to have been deleted, then the obtaining unit 118 deletes the piece of contents information from the contents information storing unit 114. If a particular piece of contents information is found to have been updated, then the obtaining unit 118 obtains the updated contents information and accordingly updates the contents information in the contents information storing unit 114. If a particular piece of contents information is found to have been added, then the obtaining unit 118 obtains the piece of contents information and adds it in the contents information storing unit 114. Regarding the startup identifiers too, operations are performed in an identical manner.

Moreover, while inquiring about contents information, with respect to a device to which an inquiry has been made earlier, the obtaining unit 118 can make a two-step inquiry. More particularly, firstly, the obtaining unit 118 inquires whether or not any modifications have been made to the contents held by the device since the previous inquiry. Only if modifications have been made to the contents, then the obtaining unit 118 inquires about the modified contents and obtains those modified contents. In this way, by making such a two-step inquiry, it becomes possible to reduce the volume of communication.

Meanwhile, the configuration can also be such that the pieces of contents information and the startup identifiers of contents holding source devices, such as the NAS 150, are held in a separate device, and the obtaining unit 118 obtains the contents information and the startup identifiers from that separate device.

The input-output unit 120 serves as a user interface. In the first embodiment, the explanation is given for an example in which information is output by means of displaying a screen on a display and information is input by means of information selection using a mouse pointer. However, that is not the only possible case; and, as long as the user interface function is implemented, any method can be adopted. For example, it is possible to perform input-output of information using sound or pressure.

The input-output unit 120 generates and displays a contents selection screen by referring to the contents information stored in the contents information storing unit 114. FIG. 4 is a diagram illustrating an example of the contents selection screen. In the contents selection screen illustrated in FIG. 4; four contents titles, namely, “AAA”, “BBB”, “CCC”, and “DDD” are displayed along with icons representing the respective details. Regarding the contents selected by a user in the contents selection screen, the input-output unit 120 obtains the contents information of the selected contents from the contents information storing unit 114, and outputs the contents information to the remote managing unit 130 (described later). Moreover, the input-output unit 120 performs video output and audio output of the contents corresponding to the data processed by the processing unit 128 (described later).

The remote control unit 122 remotely controls, via the communicating unit 112, the power state of the contents holding source devices such as the NAS 150.

When an instruction for switching a contents holding source device to the power ON state is received from the remote managing unit 130 (described later), the remote control unit 122 issues a startup request via the communicating unit 112. More particularly, from the remote managing unit 130 (described later), the remote control unit 122 receives a device identifier and an instruction to switch the device identified by the device identifier to the power ON state. In response, the remote control unit 122 obtains, from the startup identifier storing unit 116, the startup identifier (in the first embodiment, the MAC address) corresponding to the received device identifier; generates a startup request using the obtained startup identifier; and broadcasts or multicasts the generated startup request from the communicating unit 112 to the network 102. Regarding the startup request, it is possible to use, for example, the magic packet of the WOL technique. According to the WOL technique, except for some circuits such as the NIC, the power to the circuits of a device is switched OFF; and when a packet called magic packet is received that contains a specific bit pattern related to the MAC address of the device, the NIC switches ON the power of the device.

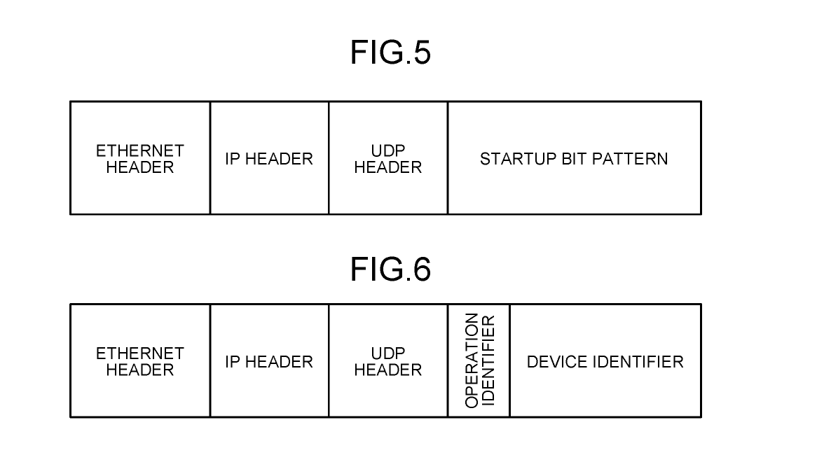

FIG. 5 is a diagram illustrating an exemplary format of a startup request according to the first embodiment. In the example illustrated in FIG. 5, as a startup request, a UDP datagram is IP-packetized into an Ethernet frame and includes an Ethernet header, an IP header, a UDP header, and a startup bit pattern.

In the destination address of the Ethernet header, either the MAC address (for example, 00:23:18:D9:50:43) of the device to which the startup request is to be sent (for example, the NAS 150) is specified, or a multicast address such as “01:00:5 E:01:01:01” is specified, or a broadcast address such as “FF:FF:FF:FF:FF:FF” is specified.

In the destination address of the IP header, a multicast address such as “224.1.1.1” or a broadcast address such as “133.111.111.255” is specified.

In the source address of the IP header, the source address (IP address) of the device that issues the startup request (herein, the TV 110) is specified. However, if no IP address is set in the device that issues the startup request, then 0.0.0.0 is specified in the source address of the IP header.

In the startup bit pattern, a pattern is specified that is generated from the MAC address of the device to which the startup request is to be sent. For example, a pattern is specified in which FFFFFFFFFFFF (hexadecimal description) is followed by 16 times of the MAC address of the device to which the startup request is to be sent.

Meanwhile, the remote control unit 122 receives a startup notification from the contents holding source device via the communicating unit 112.

FIG. 6 is a diagram illustrating an exemplary format of a startup notification according to the first embodiment. In the example illustrated in FIG. 6, as a startup notification, a UDP datagram is IP-packetized into an Ethernet frame and includes an Ethernet header, an IP header, a UDP header, an operation identifier, and a device identifier.

In the destination address of the Ethernet header, either the MAC address of the device to which the startup notification is to be sent (herein, the TV 110) is specified, or a multicast address such as “01:00:5 E:01:01:01” is specified, or a broadcast address such as “FF:FF:FF:FF:FF:FF” is specified.

In the destination address of the IP header, a multicast address such as “224.1.1.1” or a broadcast address such as “133.111.111.255” is specified.

In the source address of the IP header, the source address (IP address) of the device that sends the startup notification (herein, the NAS 150) is specified. However, if no IP address is set in the device that sends the startup notification, then “0.0.0.0” is specified in the source address of the IP header.

In the operation identifier, it is specified that the notification is a startup notification.

In the device identifier is specified the device identifier (for example, a UUID or an FQDN) of the device that sends the startup notification (herein, the NAS 150).

Once the startup notification is received, the remote control unit 122 notifies the remote managing unit 130 of the device identifier and the IP address included in the received startup notification and of the fact that the device identified by the device identifier has switched to the power ON state.

Meanwhile, when an instruction for switching a contents holding source device to the sleep state is received from the remote managing unit 130, the remote control unit 122 issues a GoSleep request via the communicating unit 112. More particularly, from the remote managing unit 130, the remote control unit 122 receives a device identifier and an instruction to switch the device identified by the device identifier to the sleep state. In response, the remote control unit 122 generates a GoSleep request using the received device identifier, and broadcasts or multicasts the generated GoSleep request from the communicating unit 112 to the network 102.

Regarding a GoSleep request, it is possible to use the same format as the format of a startup request illustrated in FIG. 6. In this case, in the operation identifier, it is specified that the request is a GoSleep request. Herein, for example, the NAS 150 is the device to which the GoSleep request is to be issued, and the TV 110 is the device that issues the GoSleep request.

The data reception control unit 124 controls, via the communicating unit 112, the reception of the data of contents from a contents holding source device.

When an instruction for starting data reception from a contents holding source device is received from the remote managing unit 130 (described later), the data reception control unit 124 issues a data request to the contents holding source device via the communicating unit 112. More particularly, from the remote managing unit 130, the data reception control unit 124 receives the IP address of the device to which a data request is to be issued and receives contents information containing the target data (contents) for reception, as well as receives an instruction to start data reception. Then, the data reception control unit 124 generates a data request using the received IP address and the contents information, and sends the data request to the intended device via the communicating unit 112.

In the first embodiment, it is assumed that a data request contains a contents access identifier having an IP address set therein; contains data transfer rate settings (Bulk); and contains a request start position (Position) and a request size (Size) of the data to be requested. However, a data request is not limited to such a structure.

For example, assume that the device to which a data request is to be issued has the IP address “133.111.111.111”, and the contents information of the target data (contents) for reception contains a contents access identifier “http://[host_ip]/contents/movie/AAA.wmv”. In that case, the data reception control unit 124 replaces the portion “[host_ip]” of the contents access identifier with “133.111.111.111” so as to set the IP address in the contents access identifier, and modifies the contents access identifier to “http://133.111.111.111/contents/movie/AAA.wmv”. The contents access identifier indicates that the HTTP protocol is used to request a path “/contents/movie/AAA.wmv” with respect to the IP address “133.111.111.111” by means of the GET method. Meanwhile, for example, if it is desired that the data transfer is performed at a faster data transfer rate than the normal data transfer rate with respect to the device to which a data request is to be issued, then the data reception control unit 124 sets “Bulk=ON”. Moreover, for example, if the requested data size is 10 MB starting from the 0-th MB of the data of the contents, then the data reception control unit 124 sets “Position=0 MB” and sets “Size=10 MB”. In that case, the HTTP message for data request is generated in the following manner by the data reception control unit 124: GET/contents/movie/AAA.wmv?Bulk=ON&Position=0MB&Size=10MB HTTP/1.1.

Furthermore, for example, if the requested data size is 10 MB starting from the 10-th MB of the data of the contents so as to obtain the following piece of data, the data reception control unit 124 sets “Position=10 MB” and sets “Size=10 MB”. In this case, the HTTP message for data request is generated in the following manner by the data reception control unit 124: GET/contents/movie/AAA.wmv?Bulk=ON&Position=10MB&Size=10MB HTTP/1.1.

Meanwhile, it is desirable that the request size is determined according to the memory capacity of the buffer 126. For example, the data reception control unit 124 can set the request size identical to the memory capacity of the buffer 126. Moreover, if the data transfer rate is slow from the device to which a data request is to be issued, the data reception control unit 124 can take into account the amount of time required for data transfer and set the request size as the sum of the data volume processed by a processing unit 128 (described later) during that period of time and the memory capacity of the buffer 126. Furthermore, if the size of the unreceived data (i.e., the remaining data of the contents) is smaller than the request size, then the data reception control unit 124 sets the request size as the size of the unreceived data. For that, the data reception control unit 124 can compare the contents size specified in the contents information and the size of the data of the already-received contents, and can determine whether or not the size of the unreceived data is smaller than the request size.

Besides, every time the data reception control unit 124 can set a different request size. For example, the data reception control unit 124 can determine the request size according to the volume of data stored in the buffer 126. In that case, smaller the volume of data stored in the buffer 126, greater becomes the request size. As a result, it becomes possible to store (retain) a large volume of data in the buffer 126 and to shorten the duration of the sleep state of the device to which a data request is to be issued.

Meanwhile, for example, if it is desired that the data transfer is performed at the normal data transfer rate with respect to the device to which a data request is to be issued, then the data reception control unit 124 can set “Bulk=OFF”.

From the device to which a data request was issued, the data reception control unit 124 receives data via the communicating unit 112 and stores the data in the buffer 126. Herein, as the buffer 126, it is possible to use, for example, a RAM. The data stored in the buffer 126 is processed by the processing unit 128 (described later). However, that is true under the assumption that the data transfer rate (data transmission rate) from the device to which a data request was issued is faster than the data processing speed (contents replaying rate) of the processing unit 128.

The data reception control unit 124 monitors the volume of data stored in the buffer 126, and determines whether or not the volume of data stored in the buffer 126 has exceeded B_sleep or determines whether or not the volume of data stored in the buffer 126 has fallen below B_min. When the volume of data stored in the buffer 126 exceeds B_sleep (as an example of satisfying a predetermined condition), the data reception control unit 124 notifies the remote managing unit 130 of the contents information of the data (contents) stored in the buffer 126 and of the possibility of discontinuing the data reception. When the volume of data stored in the buffer 126 falls below B_min, the data reception control unit 124 notifies the remote managing unit 130 of the contents information of the data (contents) stored in the buffer 126 and of a data reception resume request for resuming the data reception. However, when all data of the contents has been received, even if the volume of data stored in the buffer 126 falls below B_min, the data reception control unit 124 does not issue a data reception resume request to the remote managing unit 130. The data reception control unit 124 can compare the contents size specified in the contents information and the size of the data of the already-received contents, and can determine whether or not all data of the contents has been received.

Even when the data equivalent to the request size, which is set in a data request, is received (as an example of satisfying a predetermined condition), the data reception control unit 124 notifies the remote managing unit 130 of the contents information of the received data (contents) and of the fact that the data reception is complete.

When the data reception control unit 124 starts receiving the data of the contents and storing the data in the buffer 126, and when the volume of data stored in the buffer 126 exceeds B_play, the processing unit 128 starts processing the data and playing the contents. Regarding the details of data processing, the processing unit 128 decodes the data stored in the buffer 126 and instructs the input-output unit 120 to perform video output and audio output. Moreover, the processing unit 128 deletes the decoded data from the buffer 126. Meanwhile, B_play is used in preventing the buffer underrun error while playing the contents. It is desirable that B_play is determined by taking into account the communication delay and the decoding delay. Moreover, it is desirable that B_play is a smaller value than B_min.

The remote managing unit 130 remotely manages contents holding source devices, such as the NAS 150, by managing, in a memory unit (not illustrated), management information of the contents holding source devices. In the first embodiment, it is assumed that, for each contents holding source device, the management information is held in a corresponding manner to the device identifier, the power state, and the IP address. However, that is not the only possible case. Meanwhile, the remote managing unit 130 updates the power states and the IP addresses specified in the management information according to the details notified by the remote control unit 122.

When contents information is output from the contents information storing unit 114, the remote managing unit 130 obtains, from the management information, and confirms the device identifier specified in the contents information and the power state corresponding to that device identifier. If the power state is confirmed to be the sleep state, then the remote managing unit 130 notifies the remote control unit 122 of the device identifier specified in the contents information and instructs the remote control unit 122 to switch the device identified by the notified device identifier to the power ON state.

From the remote control unit 122, the remote managing unit 130 receives the device identifier and the IP address specified in the startup notification as well as receives a notification that the device identified by the device identifier has switched to the power ON state. Then, the remote managing unit 130 refers to the management information and updates the power state corresponding to the same device identifier to the power ON state and updates the IP address to the received IP address. Moreover, the remote managing unit 130 notifies the data reception control unit 124 of the updated IP address and the contents information output by the contents information storing unit 114, and instructs the data reception control unit 124 to start (resume) the data reception of the contents indicated by that contents information.

If the data reception control unit 124 notifies of the contents information and of the possibility of discontinuing the data reception, the remote managing unit 130 obtains, from the management information, and confirms the device identifier specified in the contents information and the power state corresponding to the device identifier. If the power state is confirmed to be the power ON state, then the remote managing unit 130 notifies the remote control unit 122 of the device identifier specified in the contents information and instructs the remote control unit 122 to switch the device identified by the notified device identifier to the sleep state. Then, the remote managing unit 130 refers to the management information and updates the power state corresponding to the same device identifier specified in the contents information to the sleep state.

If the data reception control unit 124 notifies of the contents information and of the completion of data reception, the remote managing unit 130 obtains, from the management information, and confirms the device identifier specified in the contents information and the power state corresponding to the device identifier. If the power state is confirmed to be the power ON state, then the remote managing unit 130 notifies the remote control unit 122 of the device identifier specified in the contents information and instructs the remote control unit 122 to switch the device identified by the notified device identifier to the sleep state. Then, the remote managing unit 130 refers to the management information and updates the power state corresponding to the same device identifier specified in the contents information to the sleep state.

If the data reception control unit 124 notifies of the contents information and of a data reception resume request, the remote managing unit 130 obtains, from the management information, and confirms the device identifier specified in the contents information and the power state corresponding to the device identifier. If the power state is confirmed to be the sleep state, then the remote managing unit 130 notifies the remote control unit 122 of the device identifier specified in the contents information and instructs the remote control unit 122 to switch the device identified by the notified device identifier to the power ON state.

Meanwhile, with reference to the example illustrated in FIG. 3, the configuration for controlling the power state of the TV 110 is neither illustrated nor explained.

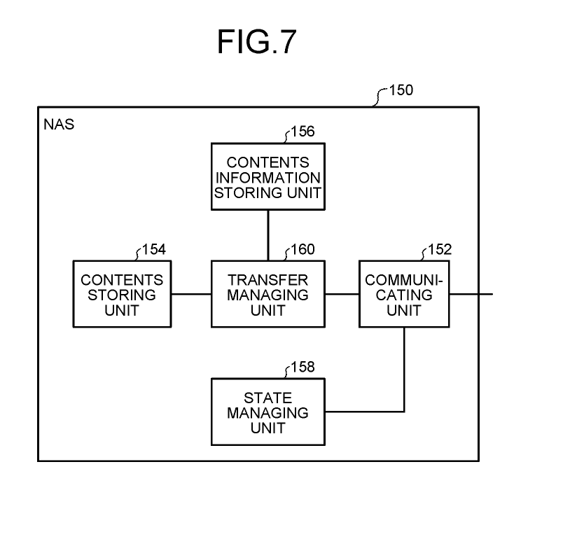

FIG. 7 is a configuration diagram illustrating an example of the NAS 150 according to the first embodiment. As illustrated in FIG. 7, the NAS 150 includes a communicating unit 152, a contents storing unit 154, a contents information storing unit 156, a state managing unit 158, and a transfer managing unit 160.

The communicating unit 152 communicates with external devices such as the TV 110 via the network 102. In an identical manner to the communicating unit 112 in the TV 110, the communicating unit 152 can be put into practice using an existing communication apparatus. In the first embodiment, the communicating unit 152 performs operations such as receiving startup requests, receiving data requests, receiving GoSleep requests, sending startup notifications, and sending data. More specifically, in order to perform such transmission and reception, the communicating unit 152 processes the Ethernet (registered trademark) physical layer, the MAC layer, the IP layer, and the transport layer (including the TCP/UDP layer).

The contents storing unit 154 is used to store therein the data of contents such as video contents or music contents.

The contents information storing unit 156 is used to store therein contents information corresponding to each set of contents stored in the contents storing unit 154.

The state managing unit 158 controls the power state of the NAS 150. More particularly, when a startup notification is received via the communicating unit 152 from a data request issuing device such as the TV 110, the state managing unit 158 switches the NAS 150 to the power ON state and obtains the IP address using, for example, the dynamic host configuration protocol (DHCP). Meanwhile, in the NAS 150, if the IP address is set in a static manner, then there is no need to newly obtain the IP address. Subsequently, the state managing unit 158 generates a startup notification using the obtained IP address, and broadcasts or multicasts the generated startup request from the communicating unit 152 to the network 102. Meanwhile, if a GoSleep request is received via the communicating unit 152 from a data request issuing device such as the TV 110, the state managing unit 158 switches the NAS 150 to the sleep state.

When an inquiry about contents information is received via the communicating unit 152 from a data request issuing device such as the TV 110, the transfer managing unit 160 obtains the intended contents information from the contents information storing unit 156 and sends the contents information to the data request issuing device. Regarding the startup identifiers too, operations are performed in an identical manner.

When a data request is received via the communicating unit 152 from a data request issuing device such as the TV 110, the transfer managing unit 160 obtains the intended data of the requested contents from the contents storing unit 154 and sends the data to the data request issuing device via the communicating unit 152. Moreover, if the received data request has “Bulk=ON” set therein, then the transfer managing unit 160 sends the intended data of the requested contents at the highest possible transfer rate irrespective of the contents playing rate of the TV 110. On the other hand, if the received data request has “Bulk=OFF” set therein, then it is desirable that the transfer managing unit 160 sends the intended data of the requested contents at a transfer rate that takes into account the number of sets of contents to be transmitted in a simultaneous manner.

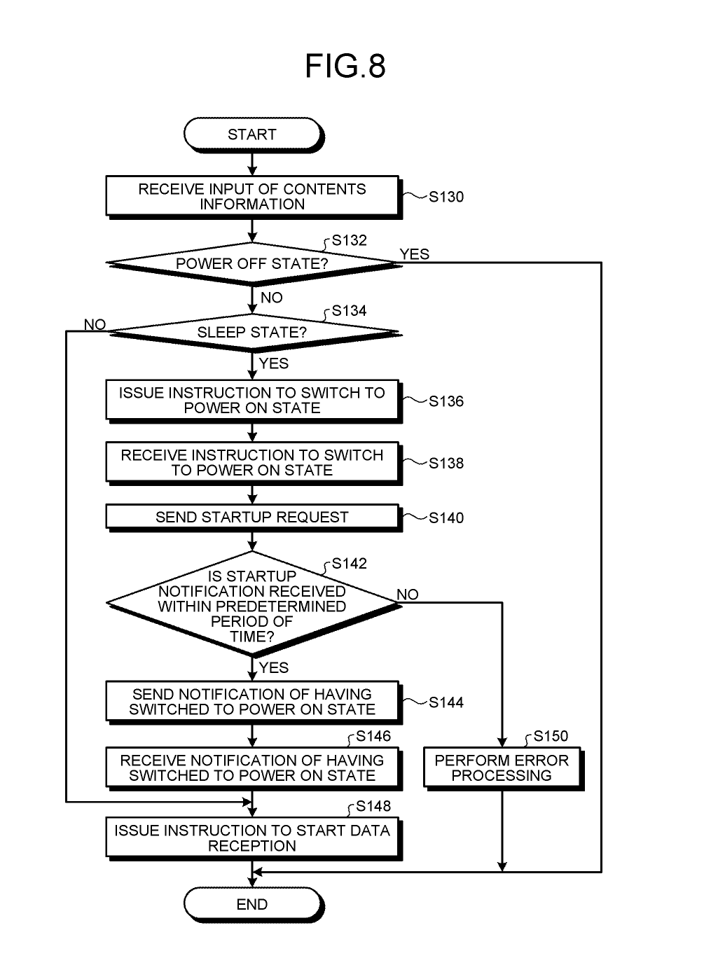

FIG. 8 is a flowchart for explaining exemplary operations of the remote control unit 122 and the remote managing unit 130 according to the first embodiment.

Firstly, the remote managing unit 130 receives input, from the input-output unit 120 via the contents information storing unit 114, of contents information of the contents selected by the user in the contents selection screen (Step S130). Then, from the management information managed in a memory unit (not illustrated), the remote managing unit 130 obtains and confirms the device identifier specified in the received contents information and the power state corresponding to the device identifier.

If the power state is confirmed to be the power OFF state (Yes at Step S132), the remote managing unit 130 ends the operations. At that time, it is desirable that the remote managing unit 130 instructs the input-output unit 120 to display an error notification on the screen.

If the power state is confirmed to be the sleep state (No at Step S132, Yes at Step S134), then the remote managing unit 130 notifies the remote control unit 122 of the device identifier specified in the received contents information and instructs the remote control unit 122 to switch the device identified by the notified device identifier to the power ON state (Step S136).

Herein, although not illustrated in FIG. 8, if the data reception control unit 124 notifies of the contents information and of a data reception resume request, then the remote managing unit 130 obtains, from the management information, and confirms the device identifier specified in the contents information and the power state corresponding to the device identifier. If the power state is confirmed to be the sleep state, then the remote managing unit 130 notifies the remote control unit 122 of the device identifier specified in the contents information and instructs the remote control unit 122 to switch the device identified by the notified device identifier to the power ON state.

Then, from the remote managing unit 130, the remote control unit 122 receives a device identifier and an instruction to switch the device identified by the device identifier to the power ON state (Step S138). In response, the remote control unit 122 obtains, from the startup identifier storing unit 116, the startup identifier corresponding to the received device identifier; generates a startup request using the obtained startup identifier; and sends the generated startup request from the communicating unit 112 to the network 102 (Step S140).

Then, if a startup notification that contains the same device identifier as the device identifier received from the remote managing unit 130 is received by the remote control unit 122 within a predetermined period of time since sending the startup request (Yes at Step S142), the remote control unit 122 notifies the remote managing unit 130 of the device identifier and the IP address included in the received startup notification and of the fact that the device identified by the device identifier has switched to the power ON state (Step S144).

Then, from the remote control unit 122, the remote managing unit 130 receives the device identifier and the IP address included in the startup notification and receives a notification that the device identified by the device identifier has switched to the power ON state (Step S146). Then, the remote managing unit 130 refers to the management information, and updates the power state corresponding to the same device identifier to the power ON state and updates the IP address to the received IP address. Moreover, the remote managing unit 130 notifies the data reception control unit 124 of the received contents information and the updated IP address, and instructs the data reception control unit 124 to start (resume) the data reception of the contents indicated by the contents information (Step S148).

Meanwhile, if the startup notification that contains the same device identifier as the device identifier received from the remote managing unit 130 is not received by the remote control unit 122 within a predetermined period of time since sending the startup request (No at Step S142), the remote control unit 122 instructs the input-output unit 120, via the remote managing unit 130, to perform error processing (Step S150). That marks the end of the operations. Herein, it is desirable that, as the error processing, the remote control unit 122 instructs the input-output unit 120 to display on the screen an error notification about failure in data reception of the contents.

Meanwhile, if the power state is confirmed to be the power ON state (No at Step S132, No at Step S134), then the remote managing unit 130 obtains, from the management information, the IP address corresponding to the same device identifier as the device identifier specified in the received contents information. Subsequently, the remote managing unit 130 notifies the data reception control unit 124 of the received contents information and the obtains IP address, and instructs the data reception control unit 124 to start (resume) the data reception of the contents indicated by the contents information (Step S148).

Herein, although not illustrated in FIG. 8, if the data reception control unit 124 notifies of the contents information and a notification about the possibility of discontinuing the data reception or about the completion of data reception, the remote managing unit 130 obtains, from the management information, and confirms the device identifier specified in the contents information and the power state corresponding to the device identifier. Then, if the power state is confirmed to be the power ON state, then the remote managing unit 130 notifies the remote control unit 122 of the device identifier specified in the contents information and instructs the remote control unit 122 to switch the device identified by the notified device identifier to the sleep state. Besides, the remote managing unit 130 refers to the management information and updates the power state corresponding to the same device identifier specified in the contents information to the sleep state.

Then, from the remote managing unit 130, the remote control unit 122 receives the device identifier and an instruction to switch the device identified by the device identifier to the sleep state. Then, the remote control unit 122 generates a GoSleep request using the received device identifier and sends the generated GoSleep request from the communicating unit 112 to the network 102.

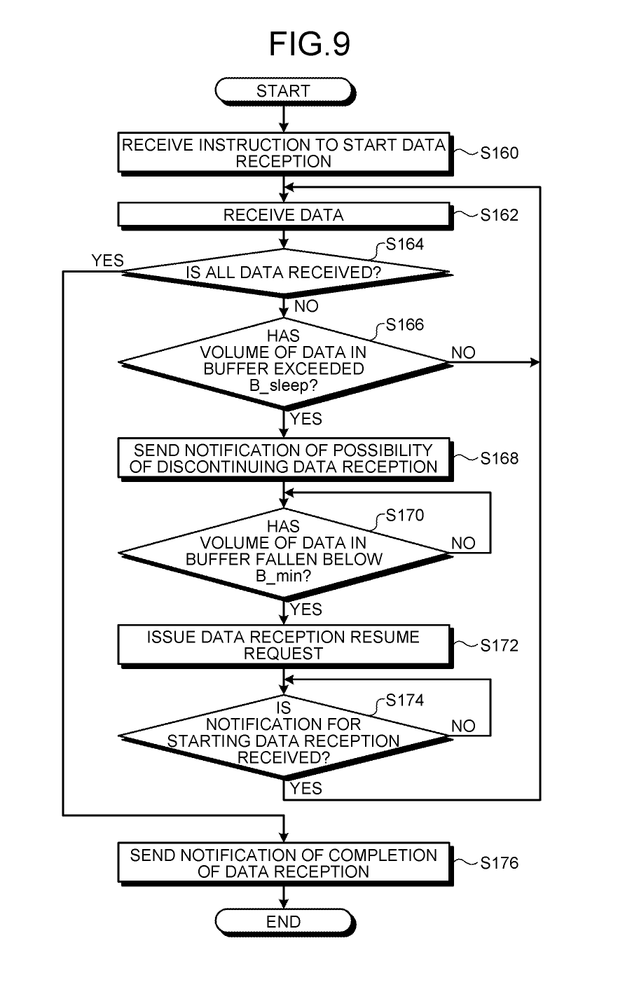

FIG. 9 is a flowchart for explaining an example of operations performed by the data reception control unit 124 according to the first embodiment.

Firstly, from the remote managing unit 130, the data reception control unit 124 receives the IP address of the device to which a data request is to be issued and receives contents information containing the target data (contents) for reception, as well as receives an instruction to start data reception (Step S160). Then, the data reception control unit 124 generates a data request using the received IP address and the contents information, and sends the data request to the device to which a data request is to be issued. For example, as an HTTP message of the data request, the data reception control unit 124 sends “GET/contents/movie/AAA.wmv?Bulk=ON&Position=0MB&Size=10MB HTTP/1.1” and requests for the data of contents equivalent to the initial 10 MB.

Then, the data reception control unit 124 receives an HTTP response from the device to which the data request was issued (Step S162) and stores the data that is included in the HTTP request in the buffer 126.

Subsequently, until all data of the contents is received or until the volume of data stored in the buffer 126 exceeds B_sleep (No at Step S164, No at Step S166), the data reception control unit 124 keeps on receiving the data (Step S162). When the volume of data stored in the buffer 126 exceeds B_sleep (Yes at Step S166), the data reception control unit 124 notifies the remote managing unit 130 of the contents information of the data (contents) stored in the buffer 126 and of the possibility of discontinuing the data reception (Step S168). Meanwhile, although not illustrated in FIG. 9, when the data equivalent to the request size set in the data request is received, the data reception control unit 124 notifies the remote managing unit 130 of the contents information of the received data (contents) and of the fact that the data reception is complete.

Then, the data reception control unit 124 waits until the volume of data stored in the buffer 126 falls below B_min (No at Step S170). When the data stored in the buffer 126 is processed by the processing unit 128 and when the volume of data stored in the buffer 126 falls below B_min (Yes at Step S170), the data reception control unit 124 notifies the remote managing unit 130 of the contents information of the data (contents) stored in the buffer 126 and of a data reception resume request for resuming the data reception (Step S172).

Subsequently, the data reception control unit 124 waits for a notification from the remote managing unit 130 for starting (resuming) data reception (No at Step S174), and receives from the remote managing unit 130 the IP address of the device to which a data request is to be issued and receives contents information containing the target data (contents) for reception, as well as receives an instruction to start data reception (Yes at Step S174). In response, the data reception control unit 124 generates a data request using the received IP address and the contents information, and sends the data request to the device to which a data request is to be issued. For example, as an HTTP message of the data request for obtaining the following piece of data, the data reception control unit 124 sends “GET/contents/movie/AAA.wmv?Bulk=ON&Position=10MB&Size=10MB HTTP/1.1” and requests for the data of contents equivalent to 10 MB starting from the 10-th MB of the data.

Then, the data reception control unit 124 receives an HTTP response from the device to which the data request was issued (Step S162) and stores the data that is included in the HTTP request in the buffer 126.

Subsequently, until all data of the contents is received or until the volume of data stored in the buffer 126 exceeds B_sleep (No at Step S164, No at Step S166), the data reception control unit 124 keeps on receiving the data (Step S162). When all data of the contents is received (Yes at Step S164), the data reception control unit 124 notifies the remote managing unit 130 of the contents information of the received data (contents) and of the fact that the data reception is complete (Step S176).

In this way, in the first embodiment, from the NAS 150 serving as a data transmitting device, the TV 110 serving as a data receiving device receives the data of contents at a higher speed than the contents playing rate, and stores therein the data. Thus, while playing contents, the TV 110 can switch the NAS 150 to the sleep state, in which data cannot be transmitted but in which the power consumption is less. More particularly, when the volume of data stored in the TV 110 exceeds B_sleep, the TV 110 switches the NAS 150, which serves as a data transmitting device, to the sleep state in which data cannot be transmitted but in which the power consumption is less. In contrast, when the volume of data stored in the TV 110 falls below B_min, the TV 110 switches the NAS 150, which serves as a data transmitting device, to the power ON state in which data can be transmitted, and receives data from the NAS 150. As a result, in the first embodiment, it becomes possible to reduce the power consumption of the NAS 150, i.e., in a wider sense, it becomes possible to reduce the power consumption of the communication system 100.

Herein, the power consumption of the NAS 150 can be reduced if Equation (1) given below is satisfied.

T(D)×P_{—on}>L(D)×P_{—on}+(T(D)−L(D))×P_{—sleep}+C_{—on}+C_{—sleep} (1)

where, T(D) represents the time taken by the TV 110 to process the data of size D; L(D) represents the time taken by the NAS 150 to send the data of size D; P_{—on} represents the power consumption of the NAS 150 in the power ON state; P_{—sleep} represents the power consumption of the NAS 150 in the sleep state; C_{—on} represents the power consumed by the NAS 150 to switch from the sleep state to the power ON state; and C_{—on} represents the power consumed by the NAS 150 to switch from the power ON state to the sleep state. Thus, the left-hand side of Equation (1) indicates the power consumption of the NAS 150 when it is always in the power ON state; while the right-hand side of Equation (1) indicates the power consumption of the NAS 150 when the power state thereof is controlled in the manner described above.

Meanwhile, Equation (1) can be modified to derive Equation (2).

T(D)−L(D)>(C_{—on}+C_{—sleep})/(P_{—on}−P_{—sleep}) (2)

Meanwhile, size D can be set to be equal to (B_sleep−B_min).

Hence, it can be noted that, greater the ratio between the data processing rate of the TV 110 and the data transmission rate of the NAS 150 and greater the size of the buffer 126 of the TV 110, greater is the extent to which the power consumption of the NAS 150 can be reduced.

Moreover, in the first embodiment, by setting “Bulk=ON” in a data request, the TV 110 informs the NAS 150 that high-speed transmission is requested. With that, the NAS 150 can distinguish whether or not the TV 110 intends to receive the data at the contents playing rate. Hence, it becomes possible to reduce the data discarding that may occur in the TV 110 due to excessive data transmission and thus becomes possible to reduce the need to retransmit the data. This enables achieving further reduction in the power consumption of the NAS 150.

Similarly, in the first embodiment, the TV 110 sets a request size in a data request. Hence, it becomes possible to reduce the data discarding that may occur in the TV 110 due to excessive data transmission and thus becomes possible to reduce the need to retransmit the data. This enables achieving further reduction in the power consumption of the NAS 150. However, if the TV 110 does not set a request size in a data request but stores a sufficient volume of data in the buffer 126, then the TCP connection with the NAS 150 can be cut off so as to stop the data transfer from the NAS 150.

In the first embodiment, with respect to the function of starting up a contents holding source device such as the NAS 150, a startup identifier is assigned. Moreover, with respect to the function of being a contents server of a contents holding source device such as the NAS 150, a device identifier is assigned. That is, in the first embodiment, a startup identifier is assigned to a physical device, while a device identifier is assigned to a virtual device performing functions. Thus, according to the first embodiment, it becomes possible to not only deal with a case when a single function (device identifier) is implemented with a plurality of physical devices (startup identifiers); but also deal with a converse case when a plurality of functions (device identifiers) is implemented with a single physical device (startup identifier).

### First Modification Example

In a first modification example, the explanation is given for an example in which a plurality of TVs is installed as data receiving devices and those TVs receive data in synchronization from a single NAS. The following explanation is given mainly regarding the differences from the first embodiment, and the constituent elements having the identical functions to those explained in the first embodiment are referred to by the same names and reference numerals. Moreover, the explanation of the same constituent elements is not repeated.

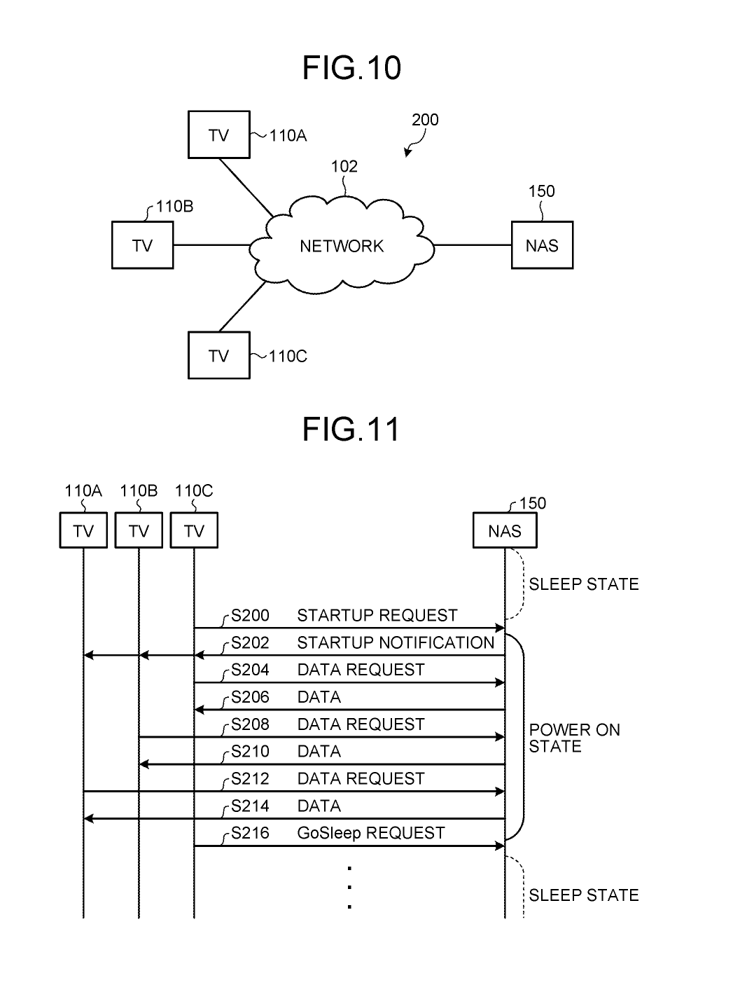

FIG. 10 is a configuration diagram illustrating an example of a communication system 200 according to the first modification example. Herein, the communication system 200 includes TVs 110A, 110B, and 110C serving as data receiving devices and includes the NAS 150 serving as a data transmitting device. The TVs 110A, 110B, and 110C and the NAS 150 are connected to each other via the network 102. Meanwhile, as long as two or more TVs are installed, the purpose is served. Moreover, it is also possible to install two or more NASs 150.

FIG. 11 is a sequence diagram illustrating an example of typical operations performed in the communication system 200 according to the first modification example. In the example illustrated in FIG. 11, it is assumed that the operations in the communication system 200 start when the TVs 110A, 110B, and 110C are in the power ON state and the NAS 150 is in the sleep state. Moreover, it is assumed that each of the TVs 110A, 110B, and 110C plays contents while receiving the data of the contents. Meanwhile, the TVs 110A, 110B, and 110C can receive the data of the same set of contents from the NAS 150 or the data of different sets of contents from the NAS 150.

Firstly, the TV 110C issues a startup request to the NAS 150 that is holding the contents regarding which the data is requested (Step S200).

Upon receiving the startup request from the TV 110C, the NAS 150 switches from the sleep state to the power ON state, and broadcasts or multicasts a startup notification to the network 102 so that the startup notification is sent to the TVs 110A, 110B, and 110C (Step S202).

Upon receiving the startup notification, each of the TVs 110A, 110B, and 110C determines whether or not the data of contents is being received from the NAS 150 and is being played by referring to the device identifier specified in the startup notification. If each of the TVs 110A, 110B, and 110C is receiving the data of contents from the NAS 150 and is playing the contents, then each of the TVs 110A, 110B, and 110C receives a data request for obtaining the data that follows the already-received data of the contents (Step S212, Step S208, Step S204) and receives the requested data from the NAS 150 (Step S214, Step S210, Step S206).

More particularly, in each of the TVs 110A, 110B, and 110C, if the device identifier specified in the contents information of the target data (contents) for reception matches with the device identifier specified in the startup notification, the corresponding data reception control unit 124 determines that the data of the contents is being received from the NAS 150 and is being played. If each of the TVs 110A, 110B, and 110C is receiving the data of contents from the NAS 150 and is playing the contents, then, irrespective of the volume of data that has already been stored in the corresponding buffer 126, the corresponding data reception control unit 124 issues a data request to the NAS 150 for obtaining the data that follows the already-received data of the contents. In this case, it is desirable that each data reception control unit 124 determines the request size according to the volume of data stored in the corresponding buffer 126. Typically, as the request size, each data reception control unit 124 can set the difference between the memory capacity of the corresponding buffer 126 and the volume of data stored in that buffer 126.

Then, after the elapse of a predetermined period of time since receiving the startup notification (as an example satisfying a predetermined condition), the TV 110C sends a GoSleep request to the NAS 150 (Step S216). Herein, the TV 110C sends a GoSleep request upon receiving the data equivalent to the request size or when the volume of data stored in the buffer 126 exceeds B_sleep, so that the data reception being performed by the TVs 110A and 110B is prevented from getting terminated midway or a data request is prevented from being issued after the NAS 150 switches to the sleep state. Upon receiving a GoSleep request from the TV 110C, the NAS 150 switches to the sleep state.

In this way, in the first modification example, once any one TV switches a NAS to the power ON state, a plurality of TVs receives data in synchronization from the same NAS. Thus, according to the first modification example, it becomes possible to reduce the number of times for which the NAS 150 is switched to the power ON state, thereby enabling achieving reduction in the power consumption of the NAS 150.

### Second Modification Example

In a second modification example, the explanation is given for an example in which the TV 110 as well as the NAS 150 includes a first communicating unit used in receiving data of contents and includes a second communicating unit used in communicating at least one of startup requests, startup notifications, and GoSleep requests.

As the first communicating units, it is possible to use NICs in an identical manner to the first embodiment. Regarding the second communicating units, since startup requests, startup notifications, and GoSleep requests have a small message size, it is possible to use the RFID technology (RFID stands for Radio Frequency IDentification) or the power saving wireless technology. In this case, the power consumption of the second communicating units is lower than the power consumption of the first communicating units. Hence, while the NAS 150 is in the sleep state, if the TV 110 and the NAS 150 stop supplying power to the respective first communicating units, it becomes possible to reduce the power consumption of the TV 110 as well as the NAS 150.

### Third Modification Example

In a third modification example, the explanation is given for a modification example of startup requests, startup modifications, and GoSleep requests. In the first embodiment, the explanation is given for the case in which startup requests, startup modifications, and GoSleep requests are communicated in Ethernet frames. Alternatively, among the TV 110 and the NAS 150, at least one of startup requests, startup modifications, and GoSleep requests can be communicated using, for example, the data pulse position of the fast link pulse (FLP). Thus, among the TV 110 and the NAS 150, at least one of startup requests, startup modifications, and GoSleep requests can be communicated using different communication means of the MAC layer than the data frames of the MAC layer. Because of that, the signals that need to be processed by the communicating units (NICs) of the TV 110 and the NAS 150 become simpler, thereby enabling achieving reduction in the standby power consumption of those communicating units.

Meanwhile, as long as switching to the power ON state can be notified, startup notifications can also be substituted with other packets. For example, it is also possible to make use of the Advertisement message of DLNA; the link layer discovery protocol (LLDP); the IEEE 802.11 beacon; or the Search frame. While substituting startup notifications with other packets, it is desirable that messages are periodically sent only during the power ON state.

Meanwhile, the TV 110 can be configured to transmit the power to the NAS 150 so as to switch the NAS 150 from the power OFF state to the power ON state. For example, the TV 110 can be configured to transmit the power to the NAS 150 via an Ethernet cable, and the NAS 150 uses the received power to switch from the power OFF state to the power ON state or the sleep state. In the case of switching to the sleep state, the NAS 150 further receives a startup request from the TV 110 to switch to the power ON state. Herein, the power transmission is not limited to the wired power transmission using an Ethernet cable or the like. Alternatively, it is also possible to use wireless power transmission.

### Fourth Modification Example

In a fourth modification example, the explanation is given regarding other methods of obtaining startup identifiers and contents information.

When a contents holding source device such as the NAS 150 is in the power ON state, it periodically broadcasts or multicasts the device identifier and the startup identifier thereof. The obtaining unit 118 of the TV 110 obtains the device identifier and the startup identifier that have been broadcast or multicast, and stores them in the startup identifier storing unit 116 if not already stored. Moreover, if a device identifier and a startup identifier, which are same as a device identifier and the startup identifier stored in the startup identifier storing unit 116, are not received for a predetermined period of time (such as for one week), then the obtaining unit 118 deletes the device identifier and the startup identifier from the startup identifier storing unit 116.

When a device identifier that is not yet stored in the startup identifier storing unit 116 is obtained, the obtaining unit 118 issues a get request for obtaining contents information to the source that sent (source that broadcast or multicast) the device identifier. In the get request for obtaining contents information, it is desirable to request for the contents information of all sets of contents held by the source that sent the device identifier. Regarding a device having the startup identifier already stored in the startup identifier storing unit 116, every time the remote control unit 122 issues a startup request after a predetermined period of time to switch the device to the power ON state, the obtaining unit 118 inquires whether there is any change in the contents information. Meanwhile, even if it is before issuing a startup request with the aim of obtaining contents information, whenever a device that has switched to the power ON state is found, it is desirable that the obtaining unit 118 inquires whether there is any change in the contents information.

Thus, in the manner described above, it is possible to obtain the device identifiers and the contents information.

### Fifth Modification Example

In a fifth modification example, the explanation is given regarding other ways of displaying the contents selection screen.

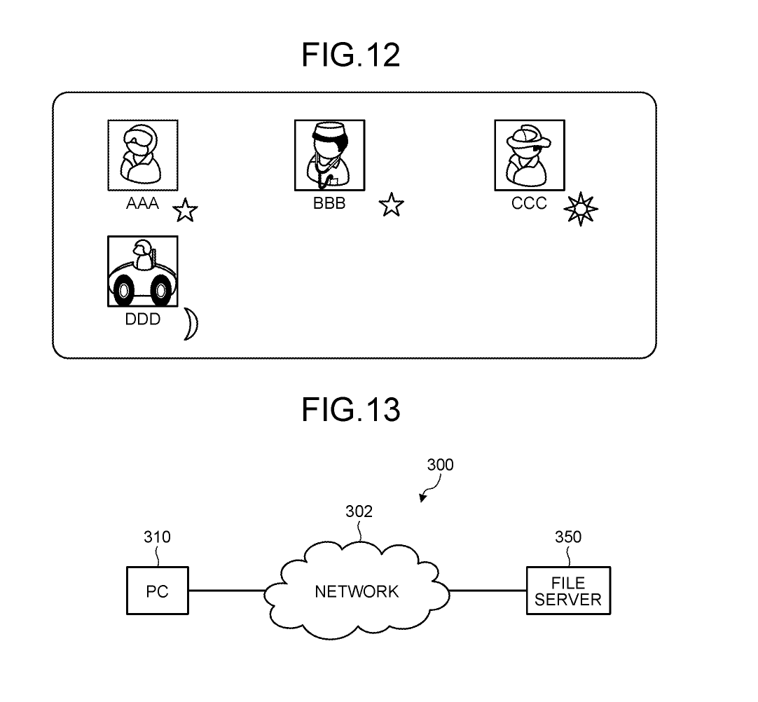

While displaying the contents selection screen, the input-output unit 120 can be configured to also display the power state of each device holding a particular set of contents. More particularly, from the management information managed by the remote managing unit 130, the input-output unit 120 obtains the power state corresponding to the device identifier that is same as the device identifier specified in a set of contents information and performs a display according to the obtained power state on the contents selection screen. FIG. 12 is a diagram illustrating an example of the contents selection screen according to the fifth modification example. In the contents selection screen illustrated in FIG. 12, four contents titles, namely, “AAA”, “BBB”, “CCC”, and “DDD” are displayed along with icons representing the respective details and along with signs indicating the power states of the devices holding the respective contents. In the example illustrated in FIG. 12, it is assumed that there are at least three or more devices that hold contents.

In FIG. 12, the titles “AAA” and “BBB” are accompanied by star signs indicating that the devices holding the respective contents are in the sleep state. The title “CCC” is accompanied by a sun sign indicating that the device holding the corresponding contents is in the power ON state. The title “DDD” is accompanied by a moon sign indicating that the device holding the corresponding contents is in the power OFF state.

By displaying such signs, the user can be notified of the power states of the devices holding contents. As a result, the user can get to know the contents that cannot be played (i.e., the contents held in a device in the power OFF state) or the contents that would take time before they can be played (i.e., the contents held in a device in the sleep state). Meanwhile, the input-output unit 120 can be so configured that, if the contents held by a device in the sleep state are selected, the moon sign displayed along with the title of that device is changed to the sun sign after that device has switched to the power ON state. As a result, the user can get to know that the contents playing would start in a short time.

### Sixth Modification Example

In a sixth modification example, the explanation is given regarding an example of application to other data other than the data of contents such as video or music.

As described in the first embodiment, if the data transfer rate (data transmission rate) of a data transmitting device (the NAS 150) is lower than the data processing speed of a data receiving device (the TV 110), data processing in the data receiving device is carried out while the data is being received. Thus, the unprocessed data gets stored in the data receiving device. By taking advantage of such a situation, the power consumption of the data transmitting device is reduced. Hence, as long as the above-mentioned situation is achieved, the explanation according to the first embodiment can be applied irrespective of the type of data, and the power consumption of the data transmitting device can be reduced.

FIG. 13 is a configuration diagram illustrating an example of a communication system 300 according to the sixth modification example. The communication system 300 includes a personal computer (PC) 310 serving as a data receiving device and a file server 350 serving as a data transmitting device. The PC 310 and the file server 350 are connected to each other via a network 302. Meanwhile, it is also possible to install two or more PCs and two or more file servers. Moreover, the file server 350 itself can also be a PC.

In the sixth modification example, the explanation is given for a case in which the network 302 is a facility network (company network) established in an office building. However, that is not the only possible case, and the network 302 can be of any type.

In the sixth modification example, the PC 310 refers to files, which are held by the file server 350, using the CIFS protocol (CIFS stands for Common Internet File System). As the processing prior to referring to the files held by the file server 350, the PC 310 issues a search request (a search command) to the file server 350; receives, from the file server 350, file information that is retrieved and stores it in a buffer; and displays the file information stored in the buffer on a screen. As the search key of the search request, it is possible to use at least any one of, for example, a portion of the file name, a character string included in the file, and date and time of modification of the file. The file information contains at least one of the file name, the date and time of modification of the file, and the file size. The PC 310 selects a set of file information displayed on a screen and refers to the file corresponding to the selected file information in the file server 350.

Meanwhile, although the PC 310 displays, on a screen, the pieces of file information retrieved by the file server 350, if a large number of files are retrieved, then it takes time to display all pieces of file information on the screen.

In that regard, in the sixth modification example, when the number of pieces of unprocessed file information that are stored in the buffer exceeds a first predetermined number, the PC 310 issues a GoSleep request to the file server 350 so that the file server 350 switches to the sleep state. Then, the PC 310 continues with the operation of displaying the unprocessed file information that is stored in the buffer. Once the number of pieces of unprocessed file information that are stored in the buffer falls below a second predetermined number, the PC 310 issues a startup request to the file server 350 so that the file server 350 switches to the power ON state. With such a configuration, it becomes possible to reduce the power consumption of the file server 350. Meanwhile, the second predetermined number is assumed to be smaller than the first predetermined number.

Subsequently, the PC 310 issues a search request to the file server 350 and resumes receiving the file information. Herein, in the search request, it is desirable that the PC 310 specifies the same session number that was specified in the previous session number. That enables the file server 350 to hold the intermediate search result.

When the file server 350 is capable of performing the file search at a faster speed than sending the file information, it is desirable that the search results are stored. For example, when a search request is received in which extraction of files modified a week ago is set as the search key (search condition); then, while extracting the files matching to the search key, the file server 350 sends the file information of the extracted files to the PC 310.

When a GoSleep request is received, the file server 350 switches to the sleep state. At that time, the file server 350 stops performing operations including file search operations and file sending operations.

Meanwhile, the file server 350 can be so configured that, during a file search operation, the PC 310 is notified that the file search operation is underway; and when the file search operation is complete, the PC 310 is notified about the completion of the file search operation. Such a configuration enables the PC 310 to issue a GoSleep request only after the file server 350 has completed the file search operation. As a result, it becomes possible to reduce the number of times for which the power state of the file server 350 is changed, thereby enabling achieving reduction in the power consumption accompanying the changes in the power states.

Thus, by getting to know the processing state of the file server 350, the PC 310 can determine whether or not the file server 350 is in a non-idle state in which there are operations to be performed. During the non-idle state of the file server 350, the PC 310 refrains from issuing a GoSleep request to the file server 350. As a result, it becomes possible to reduce the number of times for which the power state of the file server 350 is changed, thereby enabling achieving reduction in the power consumption accompanying the changes in the power states.

Alternatively, the determination about whether or not the file server 350 is in the non-idle state need not be performed by the PC 310, but can be performed by the file server 350 itself. In that case, during the non-idle state, even if a GoSleep request is received, the file server 350 can continue with the operations without switching to the sleep state and can switch to the sleep state only after finishing the operations and falling in an idle state. Thus, even without having to notify the PC 310 of the processing state of the file server 350, it becomes possible to reduce the number of times for which the power state of the file server 350 is changed, thereby enabling achieving reduction in the power consumption accompanying the changes in the power states.

Meanwhile, the explanation given in the first embodiment is also applicable to operations other than the file search operation described above. For example, the explanation can be applied to the case in which the PC 310 reads and writes the files held by the file server 350.

In that case, the PC 310 makes use of the CIFS protocol to read and write the files held by the file server 350. More particularly, the PC 310 issues a data request, in which the offset of file identifiers and the data size are specified, to the file server; receives the requested file data; stores it in the buffer; and accesses the file data stored in the buffer through an application. Herein, a file identifier points to an identifier used to uniquely identifier a requested file in the file server 350. A file identifier corresponds to, for example, the file path name. In a data request, CIFS commands such as SMB_COM_OPEN and SMB_COM_READ are used.

Of the file data stored in the buffer, when the size of the file data portion that has not been accessed yet exceeds a first size, the PC 310 issues a GoSleep request to the file server 350 so that the file server 350 switches to the sleep state. Then, the PC 310 continues with accessing the file data, which is stored in the buffer, through an application. When the size of the file data portion that has not been accessed yet falls below a second size, the PC 310 issues a startup request to the file server 350 so that the file server 350 switches to the power ON state thereby enabling resumption of receiving the file data.

Meanwhile, the explanation given in the first embodiment can not only be applied in the case of sequentially processing the data, such as contents data or search data, from the start, but also be applied in the case of random accessing such as file accessing.

### Second Embodiment

In a second embodiment, the explanation is given for an exemplary printing system in which a print server temporarily stores print data that has been sent by PCs and then sends the stored print data to a printer for printing purposes. The following explanation is given mainly regarding the differences from the first embodiment, and the constituent elements having the identical functions to those explained in the first embodiment are referred to by the same names and reference numerals. Moreover, the explanation of the same constituent elements is not repeated.

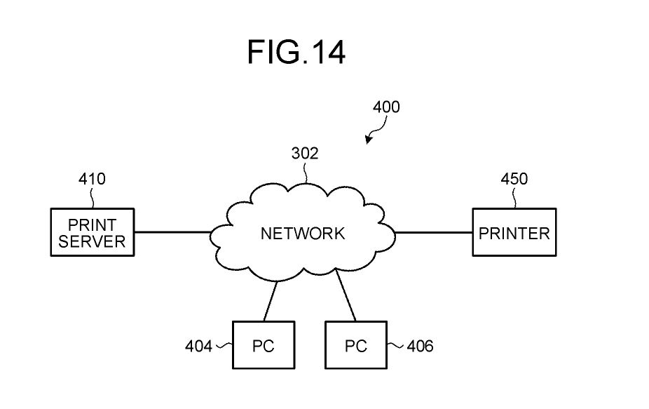

FIG. 14 is a configuration diagram illustrating an example of a communication system 400 according to the second embodiment. The communication system 400 includes PCs 404 and 406, a print server 410, and a printer 450. In the second embodiment, it is assumed that the printer 450 is an electrophotographic printer. The PC 404, the PC 406, the print server 410, and the printer 450 are connected to each other via the network 302. In an identical manner to the sixth modification example, the network 302 is assumed to be a facility network. However, that is not the only possible case, and the network 302 can be of any type.

In the second embodiment, the print server 410 and the printer 450 can switch between three power states as far as the electric power is concerned. That is, the print server 410 and the printer 450 can switch between the power ON state, the power OFF state, and the sleep state. However, the power states of the print server 410 and the printer 450 are not limited to the three power states described above. In a similar manner to the first embodiment, the sleep state can be further divided into more states such as a state corresponding to the case of increasing the temperature of a fixing roller (not illustrated) and a state corresponding to the case of lowering the temperature of the fixing roller.

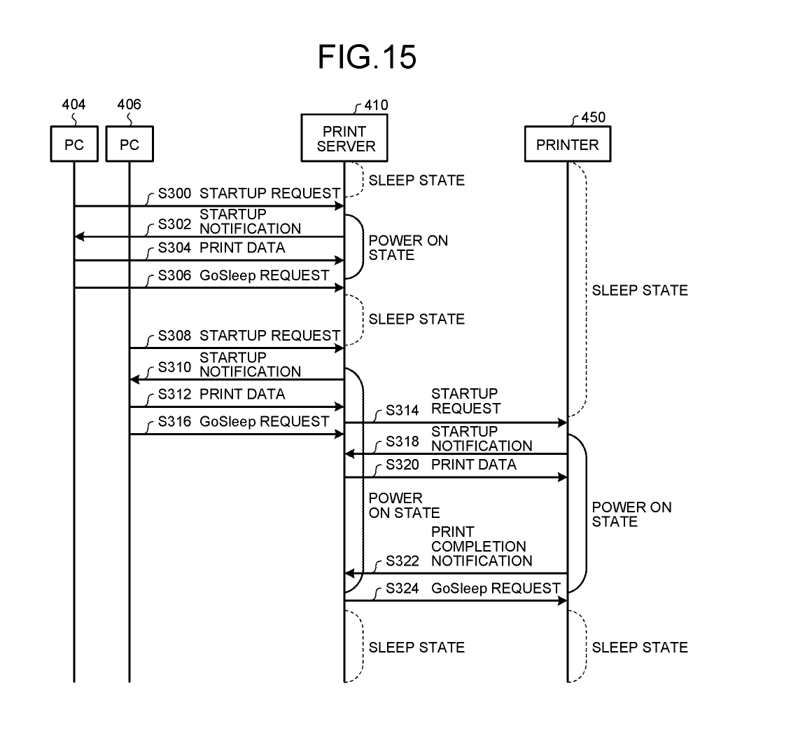

FIG. 15 is a sequence diagram illustrating an example of typical operations performed in the communication system 400 according to the second embodiment. In the example illustrated in FIG. 15, it is assumed that the operations in the communication system 400 start when the PCs 404 and 406 are in the power ON state, while the print server 410 and the printer 450 are in the sleep state.

Firstly, the PC 404 issues a startup request to the print server 410 (Step S300).

Upon receiving the startup request from the PC 404, the print server 410 switches from the sleep state to the print ON state and sends a startup notification to the PC 404 (Step S302).

Upon receiving the startup notification from the print server 410, the PC 404 sends print data to the print server 410 (Step S304). The print server 410 receives the print data from the PC 404, stores it in a buffer, and determines whether or not the volume of print data stored in the buffer has exceeded Q_print (an example of a threshold value). Herein, it is assumed that the volume of print data stored in the buffer does not exceed Q_print. In the second embodiment, the volume of print data is assumed to be the number of print jobs. However, that is not the only possible case, and the number of printing pages or the number of bytes of the print data can also be considered as the volume of print data.

Upon the completion of sending the print data, the PC 404 issues a GoSleep request to the print server 410 (Step S306). Upon receiving the GoSleep request from the PC 404, the print server 410 switches from the power ON state to the sleep state.

Then, the PC 406 issues a startup request to the print server 410 (Step S308).

Upon receiving the startup request from the PC 406, the print server 410 switches from the sleep state to the print ON state and sends a startup notification to the PC 406 (Step S310).

Upon receiving the startup notification from the print server 410, the PC 406 sends print data to the print server 410 (Step S312). The print server 410 receives the print data from the PC 406, stores it in a buffer, and determines whether or not the volume of print data stored in the buffer has exceeded Q_print. Herein, it is assumed that the volume of print data stored in the buffer exceeds Q_print.

Then, the print server 410 issues a startup request to the printer 450 (Step S314). Meanwhile, upon the completion of sending the print data, the PC 406 issues a GoSleep request to the print server 410 (Step S316). However, since the print server 410 is in the non-idle state and has to send the print data stored in the buffer to the printer 450 for the purpose of printing, the print server 410 continues with that operation without switching to the Sleep request.

Upon receiving the startup notification from the print server 410, the printer 450 switches from the sleep state to the power ON state, and sends a startup notification to the print server 410 (Step S318).

Upon receiving the startup notification from the printer 450, the print server 410 sends the print data stored in the buffer to the printer 450 (Step S320). At that time, it is desirable that the print server 410 sends all print data that is stored in the buffer to the printer 450.

Upon receiving the print data from the print server 410, the printer 450 processes the print data and generates printed material on which the print data is printed. Once all of the print data received from the print server 410 is printed, the printer 450 sends a print completion notification to the print server 410 (Step S322).

Upon receiving the print completion notification from the printer 450, the print server 410 issues a GoSleep request to the printer 450 (Step S324). At that point of time, the print server 410 is done with the operation of sending the print data stored in the buffer to the printer 450 for the purpose of printing, and hence falls in the idle state. Consequently, the print server 410 switches from the power ON state to the sleep state. Once the printer 450 receives the GoSleep request from the print server 410, it also switches from the power ON state to the sleep state.

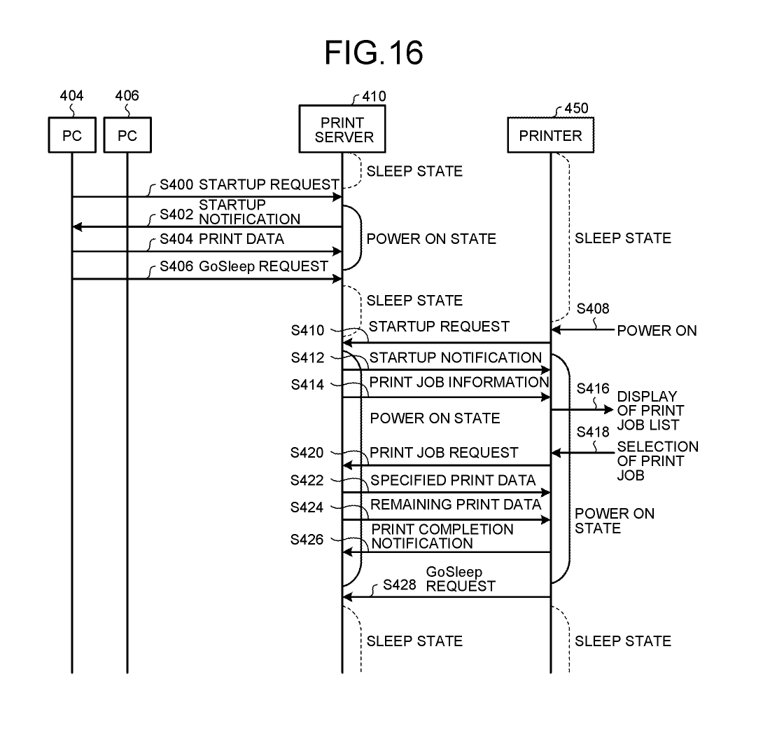

FIG. 16 is a diagram illustrating an example of operations performed in the communication system 400 according to the second embodiment in the case when the printer 450 is manually switched ON. When the printer 450 that is in the sleep state or the power OFF state switches to the power ON state in response to a trigger such as a manual operation, it is desirable that the print server 410 immediately sends the print data held in the buffer to the printer 450. That enables achieving reduction in the number of times for which the power state of the printer 450 is switched, thereby enabling achieving reduction in the power consumption of the printer 450. Meanwhile, in the example illustrated in FIG. 16 too, it is assumed that the operations in the communication system 400 start when the PCs 404 and 406 are in the power ON state, while the print server 410 and the printer 450 are in the sleep state.

Firstly, the operations from Step S400 to Step S406 are identical to the operations from Step S300 to Step S306 illustrated in FIG. 15.

Subsequently, when, for example, a user switches ON a power switch (not illustrated) of the printer 450 (Step S408), the printer 450 switches from the sleep state to the power ON state and issues a startup request to the print server 410 (Step S410). Instead, the printer 450 can also broadcast or multicast a startup request that contains device identifiers indicating all print servers.

Upon receiving the startup request from the printer 450, the print server 410 switches from the sleep state to the power ON state, and sends a startup notification to the printer 450 (Step S412).

Upon receiving the startup notification from the print server 410, the printer 450 requests the print server 410, which has sent the startup notification, for print job information (not illustrated). Herein, each piece of print job information is assumed to include a print job identifier, a print job name, and a print job sending device name (such as the PC 404). However, the information in the print job information is not limited to such items.

Upon receiving a request for print job information from the printer 450, the print server 410 sends to the printer 450 the print job information of all print jobs that are held (Step S414).

Upon receiving the print job information from the print server 410, the printer 450 displays a print job selection screen (Step S416). In the print job selection screen are displayed the print job name and the print job sending device name specified in each set of print job information. When the user selects an intended print job for printing from the print job selection screen (Step S418), the printer 450 issues a print job request, which contains the print job identifier of the selected print job, to the print server 410 (Step S420).

Upon receiving the print job request from the printer 450, the print server 410 obtains, from the buffer, the print data of the print job that is identified by the print job identifier specified in the print job request (i.e., obtains specified print data) and sends the print data to the printer 450 (Step S422). Upon receiving the print data from the print server 410, the printer 450 processes the received print data and generates printed material on which the print data is printed.

Meanwhile, when no print job is selected within a given period of time, the printer 450 sends a print job request regarding the remaining print jobs to the print server 410 (not illustrated).

Upon receiving that print job request from the printer 450, the print server 410 obtains, from the buffer, the print data of the print jobs that are identified by the print job identifiers specified in the print job request (i.e., obtains remaining print data) and sends the print data to the printer 450 (Step S424). Upon receiving the print data from the print server 410, the printer 450 processes the received print data and generates printed material on which the print data is printed.

Once all of the print data received from the print server 410 is printed, the printer 450 sends a print completion notification to the print server 410 (Step S426). In addition, the printer 450 issues a GoSleep request to the print server 410 (Step S428). Then, the printer 450 itself switches from the power ON state to the sleep state. When the print server 410 receives the GoSleep request from the printer 450, it also switches from the power ON state to the sleep state.

Meanwhile, at Step S410, the printer 450 can broadcast or can multicast not only a startup request but also a startup notification to the print server 410. With that, if the print server 410 is already in the power ON state, the startup notification serves as the trigger to send print job information to the printer 450. That enables achieving reduction in the time taken for displaying the print job selection screen.

Moreover, the configuration can be such that, upon receiving a startup request or the abovementioned startup notification at Step S410, the print server 410 sends all of the print data and the print job information held therein to the printer 450. This enables the printer 450 to refer to the received print data and the print job information, and to perform operations such as displaying the print job selection screen, printing the specified print data, and printing the remaining print data. With such a configuration, the print server 410 can switch to the sleep state without having to wait for a print completion notification from the printer 450. This enables achieving further reduction in the power consumption.

Furthermore, the configuration can be such that, upon receiving print job information from the print server 410 at Step S414, the printer 450 issues a GoSleep request to the print server 410 so that the print server 410 switches to the sleep state. Then, prior to issuing a print job request to the print server 410 at Step S420, the printer 450 issues a startup request to the print server so that the print server 410 switches to the power ON state. With such a configuration, the sleep state of the print server 410 can be lengthened in time and the power consumption thereof can be reduced.

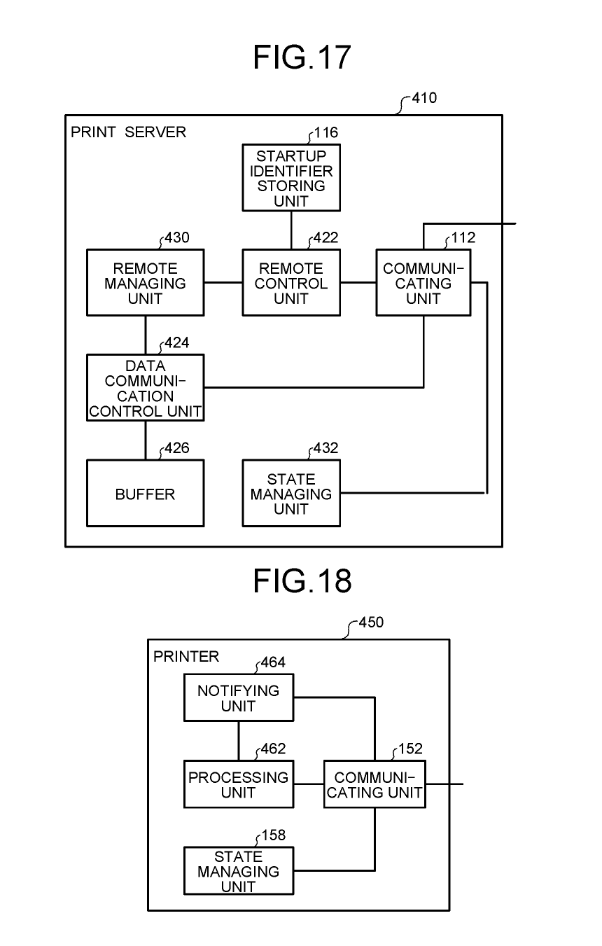

FIG. 17 is a configuration diagram illustrating an example of the print server 410 according to the second embodiment. As illustrated in FIG. 17, the print server 410 includes the communicating unit 112, the startup identifier storing unit 116, a remote control unit 422, a data communication control unit 424, a buffer 426, a remote managing unit 430, and a state managing unit 432.

The communicating unit 112 is identical to the communicating unit 112 in the TV 110 according to the first embodiment.

Regarding the startup identifier storing unit 116, except for the fact that device identifiers and startup identifiers that are stored correspond to printing devices such as the printer 450, the configuration is same as the startup identifier storing unit 116 in the TV 110 according to the first embodiment.

The remote control unit 422 remotely controls, via the communicating unit 112, the power state of the printing devices such as the printer 450. Herein, issuing startup requests, receiving startup notifications, and issuing Sleep requests is performed in an identical manner to the first embodiment. Hence, the explanation thereof is not repeated.

The data communication control unit 424 receives, via the communicating unit 112, print data from the PCs 404 and 406, and stores the received print data in the buffer 426.

Besides, the data communication control unit 424 monitors the volume of print data stored in the buffer 426 and determines whether or not the volume of print data stored in the buffer 426 has exceeded Q_print. When the volume of print data stored in the buffer 426 exceeds Q_print, the data communication control unit 424 notifies the remote managing unit 430 of the device identifier and instructs the remote managing unit 430 to switch the printing device identified by the notified device identifier to the power ON state.

Moreover, when the IP address of a printing device to which a print request is issued is received from the remote managing unit 430 along with a request for starting print data transmission, the data communication control unit 424 sends the print data, which is stored in the buffer 426, to the received IP address via the communicating unit 112.

Meanwhile, in order to determine the timing of sending the print data, the data communication control unit 424 can take into account not only the volume of print data stored in the buffer 426 but also the elapsed time since the last time of sending print data to a printing device such as the printer 450.

For example, in a printing device such as the printer 450, the temperature of the fixing roller does not decrease all on a sudden. Hence, shorter the elapsed time, lower is the power consumption required to switch the printing device from the sleep state to the power ON state. Thus, depending on the elapsed time since the last time of sending print data and depending on the volume of print data stored in the buffer 426, it becomes possible to determine whether or not to switch the printing device to the power ON state.

For example, assume that “t_e” represents the elapsed time since the last time of sending print data, assume that “n_p” represents the volume of print data stored in the buffer 426, and assume that “T1<T2” and “N1<N2<N3” hold true. In this case, if “t_e<T1” and “n_p>N1” hold true and if “t_e<T2” and “n_p>N2” or “n_p>N3” hold true, then the printing device can be switched to the power ON state.

With that, a decrease can be expected in the delay time starting from the transmission of print data from the PCs 404 and 406 to the print server 410 up to the completion of printing. Meanwhile, the print server 410 can make an inquiry to the printer 450 about the temperature of the fixing roller or about the time required to switch to the power ON state, and can accordingly determine whether or not to switch the printer 450 to the power ON state.

The remote managing unit 430 remotely manages printing devices such as the printer 450 by managing, in a memory unit (not illustrated), management information of the printing devices.

When a device identifier and a request for switching the printing device identified by the device identifier to the power ON state is received from the data communication control unit 424, the remote managing unit 430 obtains, from the management information, and confirms that device identifier and the power state corresponding to the device identifier. If the power state is confirmed to be the sleep state, then the remote managing unit 430 notifies the remote control unit 422 of the device identifier and instructs the remote control unit 422 to switch the printing device identified by the notified device identifier to the power ON state.

From the remote control unit 422, the remote managing unit 430 receives the device identifier and the IP address specified in a startup notification as well as receives a notification that the printing device identified by the device identifier has switched to the power ON state. Then, the remote managing unit 430 refers to the management information and updates the power state corresponding to the same device identifier to the power ON state and updates the IP address to the received IP address. Moreover, the remote managing unit 430 notifies the data communication control unit 424 of the updated IP address, and instructs the data communication control unit 424 to start (resume) the transmission of print data.

The state managing unit 432 controls the power state of the print server 410. More particularly, if a startup request is received via the communicating unit 112, the state managing unit 432 switches the print server 410 to the power ON state; and if a GoSleep request is received, the state managing unit 432 switches the print server to the sleep state.

Meanwhile, consider a case when the PC 404 or the PC 406 sends to the print server 410 the print data having a print completion acceptable time attached thereto. In that case, if print data that has reached the print completion acceptable time is present among the print data stored in the buffer 426, the state managing unit 432 can be configured to switch the print server 410 from the sleep state to the power ON state. Herein, it is desirable that the data communication control unit 424 sends all of the print data stored in the buffer 426 to the printing device that has switched to the power ON state. Moreover, in this case, it goes without saying that even if the print server 410 is in the sleep state, the power needs to be supplied to a time managing circuit thereof.

FIG. 18 is a configuration diagram illustrating an example of the printer 450 according to the second embodiment. As illustrated in FIG. 18, the printer 450 includes the communicating unit 152, the state managing unit 158, a processing unit 462, and a notifying unit 464.

The communicating unit 152 and the state managing unit 158 are identical to the communicating unit 152 and the state managing unit 158 in the NAS 150 according to the first embodiment.

The processing unit 462 receives print data from the print server 410, processes the received print data, and generates printed material on which the print data is printed.

Once the processing unit 462 completes the printing of all of the print data received from the print server 410, the notifying unit 464 sends a print completion notification to the print server 410.

As described above, according to the second embodiment, by configuring the print server 410 to temporarily store the print data, it becomes possible to reduce the number of times for which the power state of the printer 450 is changed, thereby enabling achieving reduction in the power consumption of the printer 450. Particularly, in an electrophotographic printer, the toner fixing operation requires that the temperature of the fixing roller is increased to a specified level. Since switching from the sleep state to the power ON state causes a lot of power consumption, the effect of reducing the power consumption is also large. On the other hand, the print server 410 consumes less power than the printer 450 while switching from the sleep state to the power ON state. Thus, by adopting the system configuration according to the second embodiment, it becomes possible to reduce the power consumption of the entire system.

Meanwhile, in the second embodiment, the explanation is given for an example in which a single printer is installed. However, it is also possible to install a plurality of printers. In that case, the configuration can be such that, while sending the print data to the print server 410, the PC 404 or the PC 406 specifies the printer to be used for printing. Moreover, the print server 410 manages the print data, which is stored in the buffer 426, on a printer-by-printer basis. Furthermore, the print server 410 sets a threshold value for each printer; and, when the volume of print data managed for a particular printer exceeds the threshold value set for that printer, switches that printer to the power ON state and sends the print data to that printer.

In the second embodiment, the explanation is given for an example in which a single print server is installed. However, it is also possible to install a plurality of print servers. In that case, when the printer 450 broadcasts or multicasts a startup notification, the print servers that receive the startup notification and that are storing the corresponding print data in a buffer can send the print data to the printer 450.

In the embodiments and the modification examples described above, the TV 110 as well as the print server 410 has the hardware configuration of a commonplace computer that includes a control device such as a central processing unit (CPU), a memory device such a read only memory (ROM) or a random access memory (RAM), an external memory device such as an HDD or an SSD, a display device such as a display, an input device such as a mouse or a keyboard, and a communication apparatus such as a communication interface (I/F).

In the embodiments and the modification examples described above, programs executed in the TV 110 and the print server 410 are recorded in the form of installable or executable files on a computer-readable recording medium such as a compact disk read only memory (CD-ROM), a compact disk readable (CD-R), a memory card, a digital versatile disk (DVD), or a flexible disk (FD).

Alternatively, the programs executed in the TV 110 and the print server 410 can be saved as downloadable files on a computer connected to the Internet or can be made available for distribution through a network such as the Internet. Still alternatively, the programs executed in the TV 110 and the print server 410 can be distributed over a network such as the Internet. Still alternatively, the programs executed in the TV 110 and the print server 410 can be stored in advance in a ROM or the like.

Each program executed in the TV 110 and the print server 410 contains modules for each of the above-mentioned constituent elements to be implemented in a computer. In practice, for example, a CPU reads a program from an HDD and runs it such that the program is loaded in a RAM. As a result, the module for each of the abovementioned constituent elements is generated in the RAM.

Although the invention has been described with respect to the abovementioned specific embodiments for a complete and clear disclosure, the appended claims are not to be thus limited but are to be construed as embodying all modifications and alternative constructions that may occur to one skilled in the art that fairly fall within the basic teaching herein set forth. For example, some of the constituent elements described in the embodiments can be deleted. Alternatively, the constituent elements described in different embodiments can be appropriately integrated.

For example, regarding the explanation according to the second embodiment, it is also possible to implement the first to third modification examples. In an identical manner, regarding the explanation according to the sixth modification example, it is also possible to further implement the first to third modification examples.

Meanwhile, in the embodiments described above, as long as a device functions as a node connected to a network, it serves the purpose. Hence, apart from the examples described above, a device can also point to a smartphone, a router, or a wireless access point.

Moreover, in the embodiments described above, a network is assumed to be a network using Ethernet (registered trademark). However, that is not the only possible case. Alternatively, it is also possible to configure a network using other technologies such as wireless LAN or Zigbee.

Furthermore, in the embodiments described above, the network protocol is assumed to be IPv4. However, that is not the only possible case. Alternatively, it is also possible to use IPv6 or the like.

In this way, according to an aspect of the invention, it becomes possible to further reduce the power consumption of a device on the other end of communication.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication apparatus comprising:
a data reception controller configured to receive data from an external device functioning in an active state via a network and store the data in a buffer;
a remote controller configured to, when a predetermined condition is satisfied, issue a request to the external device to switch to a power saving state; and
a processor configured to process the data stored in the buffer.

2. The apparatus according to claim 1, wherein, when volume of data stored in the buffer exceeds a first threshold value, the remote controller issues the request to the external device to switch to the power saving state.

3. The apparatus according to claim 2, wherein
when the volume of data stored in the buffer falls below a second threshold value that is smaller than the first threshold value, the remote controller issues a request to the external device to switch to the active state, and receives from the external device a notification that the external device has switched to the active state, and
upon receiving the notification, the data reception controller starts receiving new data.

4. The apparatus according to claim 1, wherein the remote controller receives a notification from the external device that the external device has switched to the active state and, after an elapse of a predetermined period of time since receiving the notification, issues a request to the external device to switch to the power saving state.

5. The apparatus according to claim 4, wherein
the notification of having switched to the active state contains an identifier for identifying a device that sent the notification, and
upon receiving the notification, when the identifier specified in the notification points to the external device, the data reception controller starts receiving new data from the external device.

6. The apparatus according to claim 4, wherein, when volume of data stored in the buffer falls below a second threshold value, the remote controller issues a request to the external device to switch to the active state.

7. The apparatus according to claim 1, wherein the data reception controller issues a request to the external device for high-speed transfer at a faster transfer rate than normal transfer, and receives data by means of the requested high-speed transfer.

8. The apparatus according to claim 1, wherein
the data reception controller communicates with the external device using a first communicating unit, and
the remote controller communicates with the external device using a second communicating device that is different than the first communicating unit.

9. A communication apparatus comprising:
a data communication controller configured to receive data from a first external device via a network and stores the data in a buffer; and
a remote controller configured to receive, from a second external device via the network, a notification that the second external device has switched to an active state, wherein
the data communication controller sends the data stored in the buffer to the second external device that has switched to the active state.

10. The apparatus according to claim 9, wherein, when volume of data stored in the buffer exceeds a threshold value, the remote controller issues a request to the second external device to switch from a power saving state to the active state, and receive a notification from the second external device that the second external device has switched to the active state.

11. The apparatus according to claim 9, wherein
the data communication controller communicates with the first external device and the second external device using a first communicating unit, and
the remote controller communicates with the second external device using a second communicating unit that is different than the first communicating unit.

12. A computer program product comprising a computer-readable medium including programmed instructions for communication, wherein the instructions, when executed by a computer, cause the computer to execute:
receiving data from an external device functioning in an active state via a network and storing the data in a buffer;
issuing, when a predetermined condition is satisfied, a request to the external device to switch to a power saving state; and
processing the data stored in the buffer.

13. A computer program product comprising a computer-readable medium including programmed instructions for communication, wherein the instructions, when executed by a computer, cause the computer to execute:
receiving data from a first external device via a network and storing the data in a buffer;
receiving, from a second external device via the network, a notification that the second external device has switched to an active state; and
sending the data stored in the buffer to the second external device that has switched to the active state.
